(19) United States
(12) Patent Application Publication
(10) Pub. No.: US 2013/0016306 A1
(43) Pub. Date: Jan. 17, 2013

(54) BACKLIGHT APPARATUS, METHOD FOR CONTROLLING THE SAME, AND IMAGE DISPLAY APPARATUS

(71) Applicants: Tomoyuki Ohno, Zama-shi (JP); Daisuke Takayanagi, Kawasaki-shi (JP)

(72) Inventors: Tomoyuki Ohno, Zama-shi (JP); Daisuke Takayanagi, Kawasaki-shi (JP)

(73) Assignee: CANON KABUSHIKI KAISHA, Tokyo (JP)

(21) Appl. No.: 13/542,107

(22) Filed: Jul. 5, 2012

(30) Foreign Application Priority Data
Jul. 15, 2011 (JP) 2011-156847

(51) Int. Cl. H05B 37/02; G02F 1/13357

(52) U.S. Cl. 349/61; 315/297

(57) ABSTRACT

Disclosed is a backlight apparatus of an image display apparatus capable of changing an position of a screen; the backlight apparatus comprising a plurality of light sources which are provided for a plurality of light source blocks and for which light emission can be controlled independently in relation to each of the light source blocks; a storage unit which stores data to be used in order to determine a driving signal for the light source, the data being determined so that a luminance of each of the light source blocks is included within a predetermined allowable range with respect to a target luminance in relation to each of the positions of the screen; an acquiring unit which acquires the position of the screen; and a control unit which determines the driving signal for the light source by using the data corresponding to the position of the screen.

### BACKGROUND OF THE INVENTION

1. Field of the Invention

The present invention relates to a backlight apparatus, a method for controlling the same, and an image display apparatus.

2. Description of the Related Art

The market request, which is directed to the luminance and the color reproduction ability, is highly sophisticated and diversified in relation to the image display apparatus based on the use of the liquid crystal panel. A cold cathode fluorescent lamp is predominantly used as the light source for the backlight of the image display apparatus. However, a light emitting diode (LED), which is excellent in the light emission efficiency as compared with the cold cathode fluorescent lamp, is also launched and adopted.

The light emission characteristic of LED involves the temperature dependency and the individual difference brought about upon the production. The internal temperature of the image display apparatus is distributed, and the internal temperature distribution depends on, for example, the light emission luminance of the backlight, the arrangement of heat-generating parts in the image display apparatus, the position and the shape of a heat vent. High temperature portions and low temperature portions are present. In general, LED has such a tendency that the luminance is lowered in accordance with the increase in the temperature.

Therefore, any uneven luminance sometime arises on account of the internal temperature distribution of the image display apparatus when LED is used as the light source of the image display apparatus. In relation thereto, such a technique has been suggested that the current, which is allowed to flow through LED, is adjusted in accordance with a temperature detected value of an LED block so that the luminance is uniform in a screen (for example, Japanese Patent Application Laid-open No. 2006-031977).

### SUMMARY OF THE INVENTION

The rotational position of the screen, which includes, for example, the “lateral position” and the “vertical position”, can be changed by a rotating mechanism in some image display apparatuses, and the angle of the screen, which is provided with respect to an observer, can be changed by a tilt mechanism in other image display apparatuses.

In the case of the image display apparatus in which the position of the screen can be changed as described above, the internal temperature distribution of the image display apparatus is greatly changed when the position of the screen is changed. FIG. 12 schematically shows the difference in the internal temperature distribution of an image display apparatus when the position of a screen is changed. FIG. 12A shows a temperature distribution obtained in a state in which the position of the screen is the lateral (landscape) position, and FIG. 12B shows a temperature distribution obtained in a state in which the position of the screen is the vertical (portrait) position. In the case of the conventional technique described above, no consideration is made about the arrangement of the temperature sensor and the change of the internal temperature distribution pattern in the image display apparatus to be brought about by the change of the position of the screen. Therefore, any uneven luminance and any uneven color arise in some cases when the position of the screen is changed.

In view of the above, the present invention provides such a technique that any uneven luminance and any uneven color can be suppressed irrelevant to the position of a screen in an image display apparatus in which the position of the screen can be changed.

A first aspect of the present invention resides in a backlight apparatus of an image display apparatus capable of changing an position of a screen; the backlight apparatus comprising a plurality of light sources which are provided for a plurality of light source blocks and for which light emission can be controlled independently in relation to each of the light source blocks; a storage unit which stores unevenness correction data as data to be used in order to determine a driving signal for the light source of each of the light source blocks, the unevenness correction data being determined so that a luminance of each of the light source blocks is included within a predetermined allowable range with respect to a target luminance in relation to each of a plurality of predetermined positions of the screen; an acquiring unit which acquires the position of the screen; and a control unit which determines the driving signal for the light source of each of the light source blocks by using the unevenness correction data corresponding to the position of the screen.

A second aspect of the present invention resides in a method for controlling a backlight apparatus of an image display apparatus capable of changing an position of a screen, the backlight apparatus comprising a plurality of light sources which are provided for a plurality of light source blocks and for which light emission can be controlled independently in relation to each of the light source blocks; the method comprising a reading step of reading unevenness correction data as data to be used in order to determine a driving signal for the light source of each of the light source blocks, the unevenness correction data being determined so that a luminance of each of the light source blocks is included within a predetermined allowable range with respect to a target luminance in relation to each of a plurality of predetermined positions of the screen; an acquiring step of acquiring the position of the screen; and a step of determining the driving signal for the light source of each of the light source blocks by using the unevenness correction data corresponding to the position of the screen.

According to the present invention, any uneven luminance and any uneven color can be suppressed irrelevant to the position of the screen in the image display apparatus in which the position of the screen can be changed.

Further features of the present invention will become apparent from the following description of exemplary embodiments with reference to the attached drawings.

### BRIEF DESCRIPTION OF THE DRAWINGS

FIG. 1 shows a block diagram illustrating main parts or components of a liquid crystal display apparatus according to a first embodiment.

FIG. 2A, 2B, and 2C shows an arrangement of a backlight according to the embodiment.

FIG. 3A, 3B, 3C, and 3D shows exemplary unevenness correction data according to the embodiment.

FIG. 4 shows an exemplary operation flow of a backlight control unit according to the first embodiment.

FIG. 5 shows an exemplary operation flow of the backlight control unit according to the first embodiment.

FIG. 6 shows an exemplary operation flow of a backlight control unit according to a second embodiment.

FIG. 7 shows an exemplary operation flow of the backlight control unit according to the second embodiment.

FIG. 8 shows exemplary table data to be used when the unevenness correction data change time is determined according to a third embodiment.

FIG. 9 shows a block diagram illustrating main parts or components of a liquid crystal display apparatus according to a fourth embodiment.

FIG. 10 shows an exemplary operation flow of a backlight control unit according to a fourth embodiment.

FIG. 11A and 11B shows points for acquiring temperature sensor values according to the fourth embodiment.

FIG. 12A and 12B schematically shows the difference in the internal temperature distribution brought about when the position of a screen is changed.

### DESCRIPTION OF THE EMBODIMENTS

### First Embodiment

A first embodiment of the present invention will be explained below with reference to the drawings.

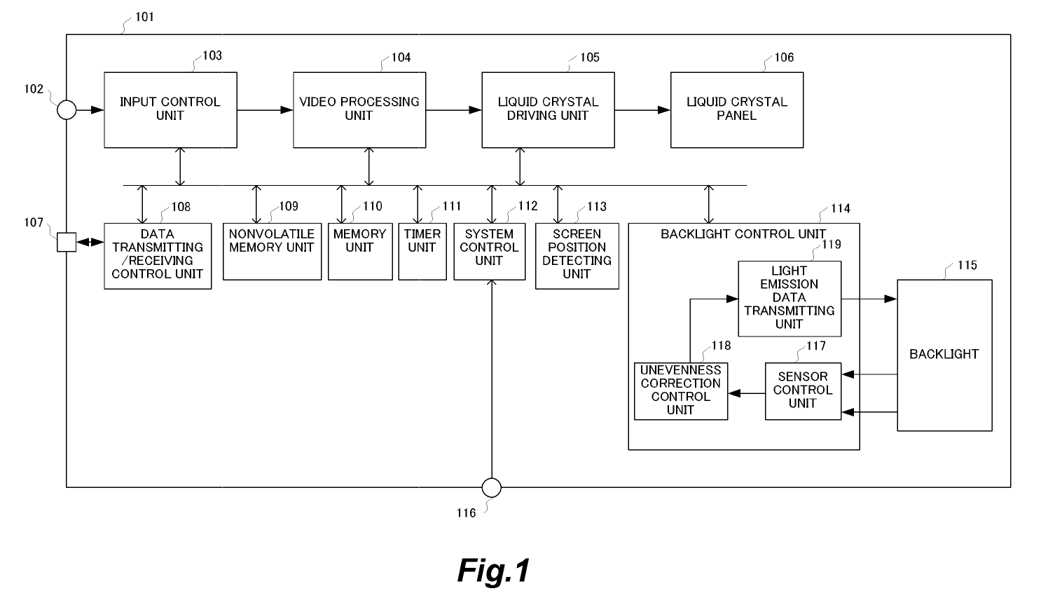

FIG. 1 shows a block diagram illustrating main parts or components of a liquid crystal display apparatus according to the present invention.

The liquid crystal display apparatus 101 shown in FIG. 1 comprises a video input unit 102, an input control unit 103, a video processing unit 104, a liquid crystal driving unit 105, a liquid crystal panel 106, a data transmitting/receiving unit 107, a data transmitting/receiving control unit 108, a nonvolatile memory unit 109, a memory unit 110, a timer unit 111, a system control unit 112, a screen position detecting unit 113, a backlight control unit 114, a backlight 115, and a power source button 116. The backlight control unit 114 comprises a sensor control unit 117, an unevenness correction control unit 118, and a light emission data transmitting unit 119.

The backlight 115 illuminates the liquid crystal panel 106 from the back surface. The illumination light, which is emitted from the backlight 115, is transmitted through respective pixels of the liquid crystal panel 106 at transmittances corresponding to the driving signal inputted from the liquid crystal driving unit 105. Accordingly, an image is displayed on the liquid crystal panel 106.

The liquid crystal display apparatus 101 is supported by a stand which has a rotating mechanism to effect the rotation about the axis perpendicular to the screen. The liquid crystal display apparatus 101 is constructed so that the rotational position of the screen can be switched over to the “lateral position” or the “vertical position”. The rotating mechanism, which effects the rotation about the axis perpendicular to the screen, may be constructed such that the rotation can be performed within a predetermined regulated angle range, for example, by 90° in the clockwise direction or in the counterclockwise direction on the basis of the lateral position. Alternatively, the rotating mechanism may be constructed so that the rotation can be performed by 360°. The rotational position, which can be switched over, is not limited to the lateral position and the vertical position.

The screen position detecting unit 113 detects the rotational position of the present screen of the liquid crystal display apparatus 101, and the obtained result is outputted as the screen position information. In this embodiment, the screen position information is the information which indicates that the rotational position of the screen is either the “lateral position” or the “vertical position”.

At first, an explanation will be made about a basic video display function of the liquid crystal display apparatus 101.

About Display of Screen Image after Turning ON Power Source

If the system control unit 112 detects a request for turning ON the power source as the power source button 116 is depressed, the application of electric power is started with respect to the respective functional blocks included in the liquid crystal display apparatus 101.

A video signal, which is inputted from the video input unit 102, is transmitted by the input control unit 103 to the video processing unit 104.

The video processing unit 104 converts the inputted video signal into the image data which is suitable for the display resolution, the number of display colors, and the refresh rate of the liquid crystal panel 106, and the image data is transmitted to the liquid crystal driving unit 105 at an appropriate timing.

The image data, which is received from the video processing unit 104, is converted by the liquid crystal driving unit 105 into the control signal for the liquid crystal panel 106, and the control signal is transmitted to the liquid crystal panel 106. Accordingly, the liquid crystal panel 106 is controlled to display the screen image (picture) based on the video signal on the liquid crystal panel 106.

The system control unit 112 makes the request to start the backlight lighting control with respect to the backlight control unit 114 so that the backlight 115 is turned ON (lighted). The operation of the backlight control unit 114 will be described later on.

### About Backlight

The backlight 115 is provided on the back surface of the liquid crystal panel 106. The backlight 115 illuminates the liquid crystal panel 106 from the back surface of the liquid crystal panel 106. The backlight 115 is provided with a plurality of LEDs as light sources. The backlight 115 is divided into a plurality of light source blocks. One LED or a plurality of LEDs is/are provided for each of the light source blocks. The light emission of LED can be controlled independently for each of the light source blocks. The light source block is hereinafter referred to as “LED block”.

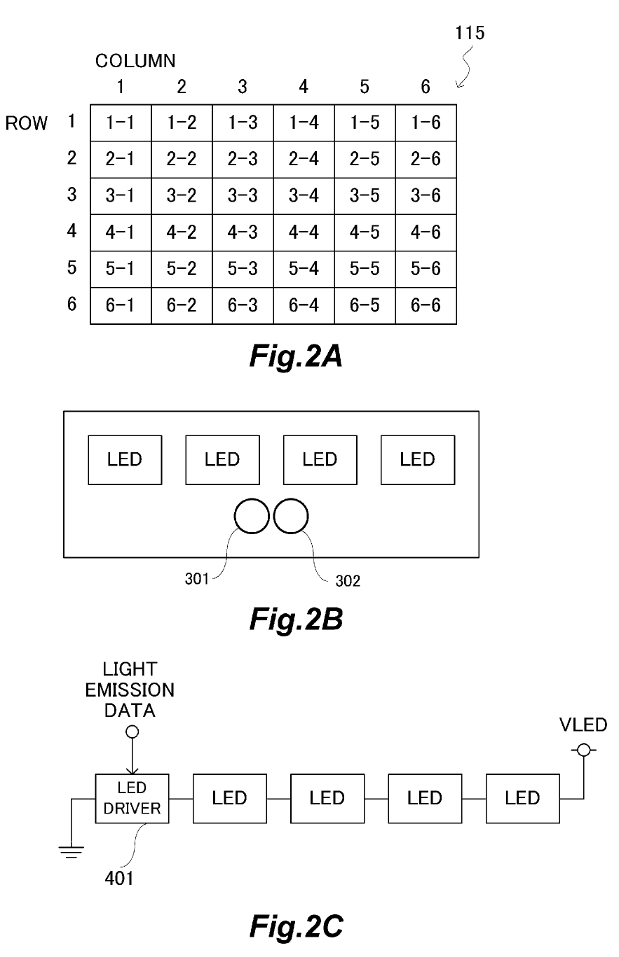

FIG. 2A shows exemplary division based on the plurality of LED blocks of the backlight 115. FIG. 2B shows an exemplary arrangement of LEDs, a luminance sensor, and a temperature sensor in each of the LED blocks. FIG. 2C shows exemplary connection of LEDs in each of the LED blocks.

As shown in FIG. 2A, the backlight 115 of this embodiment is composed of LED blocks disposed in 6 rows and 6 columns, i.e., thirty-six LED blocks in total. As shown in FIG. 2B, each of the LED blocks is arranged with four LEDs, one luminance sensor 301, and one temperature sensor 302. The way of division based on LED blocks and the number and the positional relationship concerning LEDs, the luminance sensor, and the temperature sensor arranged in each of the LED blocks are not limited to those exemplarily described above by way of example.

As shown in FIG. 2C, four LEDs of each of the LED blocks are connected in series. An LED driver 401 is provided for each of the LED blocks in order that the current is allowed to flow through LEDs to cause the light emission. The LED driver 401 receives the light emission data from the light emission data transmitting unit 119 shown in FIG. 1. LEDs are subjected to the light emission in accordance with the PWM (Pulse Width Modulation) control on the basis of the received light emission data. In this embodiment, it is assumed that the PWM control, in which duties at 4096 levels can be set, is performed. It is assumed that the light emission data value (hereinafter referred to as “PWM control value”), which is received from the light emission data transmitting unit 119, provides values of 0 to 4095, and the PWM control value and the duty correspond to one-to-one. In other words, the light emission data value (PWM control value) is the data to determine the driving signal for LED. LED causes the light emission at a luminance corresponding to the PWM control value.

For example, if PWM control value is 0, then the duty is 0, and LED does not perform the light emission. If the PWM control value is 4095, then the duty has the maximum value, and the LED performs the light emission at the maximum luminance. The light emission amount of LED may be controlled by regulating the current value. In this case, the light emission data, which is provided to determine the driving signal for LED, may be a current value allowed to flow through LED or a predetermined numerical value corresponding to the current value.

### Operation of Backlight Control Unit 114

Next, an explanation will be made about the lighting control of the backlight 115 performed by the backlight control unit 114.

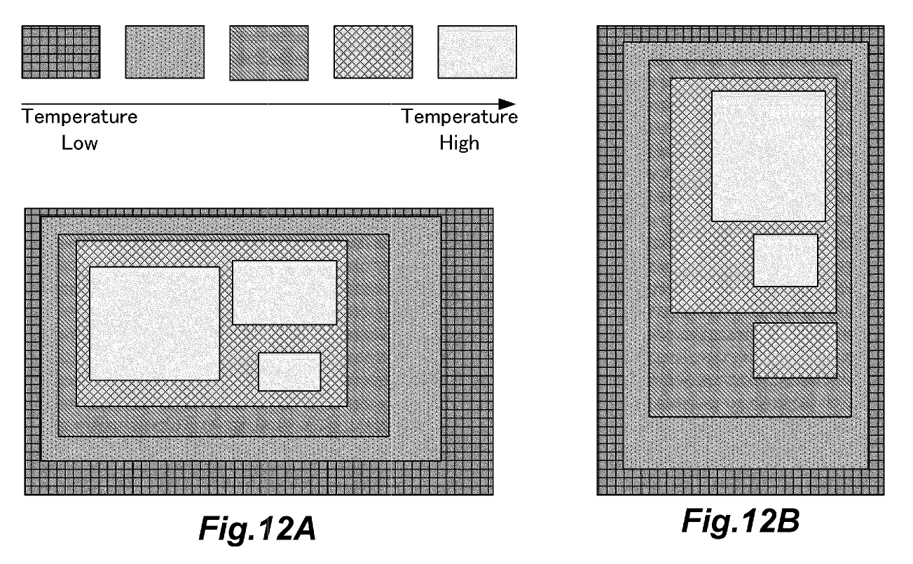

The light emission characteristic of LED involves the individual difference brought about upon the production. Therefore, even when LEDs of the respective LED blocks of the backlight 115 are subjected to the light emission with an identical PWM control value, then the luminance is dispersed in relation to each of the LED blocks, and the uneven luminance arises in some cases. Further, the light emission characteristic of LED involves the temperature dependency, and the internal temperature of the liquid crystal display apparatus 101 is distributed. Therefore, the uneven luminance arises on account of the internal temperature distribution in the liquid crystal display apparatus 101. Further, as shown in FIG. 12, the internal temperature distribution of the liquid crystal display apparatus 101 changes depending on the rotational position of the screen of the liquid crystal display apparatus 101. Therefore, the way of appearance of the uneven luminance is dispersed depending on the rotational position of the screen as well.

The liquid crystal display apparatus 101 of this embodiment stores, in the nonvolatile memory unit 109, a table of the PWM control values determined for each of the LED blocks so that the uneven luminance in the screen is minimized, as the unevenness correction data. The phrase “the uneven luminance in the screen is minimized” means, for example, that the luminance of each of the LED blocks is included within a predetermined allowable range with respect to a target luminance”. The phrase “the luminance of the LED block is included within the allowable range with respect to the target luminance” means that the absolute value of the difference between the luminance of the LED block and the target luminance is not more than a certain threshold value. The threshold value can be determined experimentally and/or empirically, for example, on the basis of the statistic in relation to the image quality evaluation performed by a plurality of observers. However, the method for quantitatively measuring the uneven luminance in the screen is not limited thereto.

The unevenness correction data is prepared by using, for example, an unillustrated measuring apparatus for every rotational position of the screen and every target luminance of the backlight at a specified environmental temperature upon the shipping adjustment performed for the liquid crystal display apparatus 101 in a factory. The data transmitting/receiving control unit 108 of the liquid crystal display apparatus 101 receives the unevenness correction data via the data transmitting/receiving unit 107. The received unevenness correction data is stored in the nonvolatile memory unit 109. For example, EEPROM (Electrically Erasable Programmable Read-Only Memory) is used for the nonvolatile memory unit 109.

The liquid crystal display apparatus 101 stores the unevenness correction data for each of the rotational positions of the screen. Therefore, if the rotational position of the screen is changed, the unevenness correction data, which serves as the reference or basis to determine the PWM control value for each of the LED blocks, can be changed to the unevenness correction data which corresponds to the rotational position after the change. Therefore, it is possible to appropriately suppress the uneven luminance of each of the LED blocks irrelevant to the rotational position of the screen. If the unevenness correction data is not stored for each of the rotational positions of the screen, i.e., even if the single unevenness correction data is used irrelevant to the rotational position of the screen, the uneven luminance can be suppressed to some extent by frequently detecting the temperature by means of the temperature sensor arranged for each of the LED blocks. However, when the unevenness correction data is previously stored for each of the rotational positions of the screen as in the present invention, the reference data, which is used to determine the PWM control value for each of the LED blocks, is the more appropriate data corresponding to the rotational position of the screen. Therefore, the accuracy to suppress the uneven luminance is enhanced. For example, even when the frequency is low in relation to the temperature detection performed by the temperature sensor arranged for each of the LED blocks, it is possible to appropriately suppress the uneven luminance for each of the LED blocks irrelevant to the rotational position of the screen.

The liquid crystal display apparatus 101 of this embodiment stores the unevenness correction data in an amount corresponding to twenty screens in total for every rotational position of the screen (lateral position, vertical position) and every target luminance of the backlight (from 20 to 200 cd/m², interval of 20 cd/m²). The PWM control value for each of the LED blocks, which is determined so that the magnitude of the difference between the luminance of each of the LED blocks and the target luminance is not more than a threshold value at each rotational position and each target luminance, is set for each piece of the unevenness correction data. In this section, an example, in which the unevenness correction data is prepared at every interval of 20 cd/m² of the target luminance, has been explained. However, the luminance interval is not limited to this example.

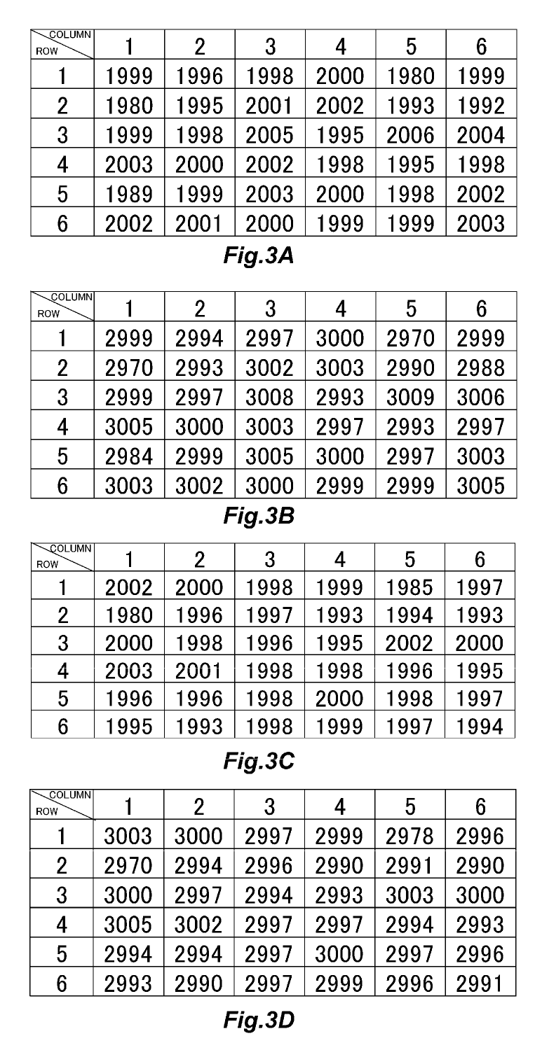

FIG. 3 shows exemplary unevenness correction data.

FIG. 3A shows exemplary unevenness correction data to be used when the rotational position of the screen of the liquid crystal display apparatus 101 resides in the “lateral position”, and the target luminance is “100 cd/m²”.

FIG. 3B shows exemplary unevenness correction data to be used when the rotational position of the screen of the liquid crystal display apparatus 101 resides in the “lateral position”, and the target luminance is “200 cd/m²”.

FIG. 3C shows exemplary unevenness correction data to be used when the rotational position of the screen of the liquid crystal display apparatus 101 resides in the “vertical position”, and the target luminance is “100 cd/m²”.

FIG. 3D shows exemplary unevenness correction data to be used when the rotational position of the screen of the liquid crystal display apparatus 101 resides in the “vertical position”, and the target luminance is “200 cd/m²”.

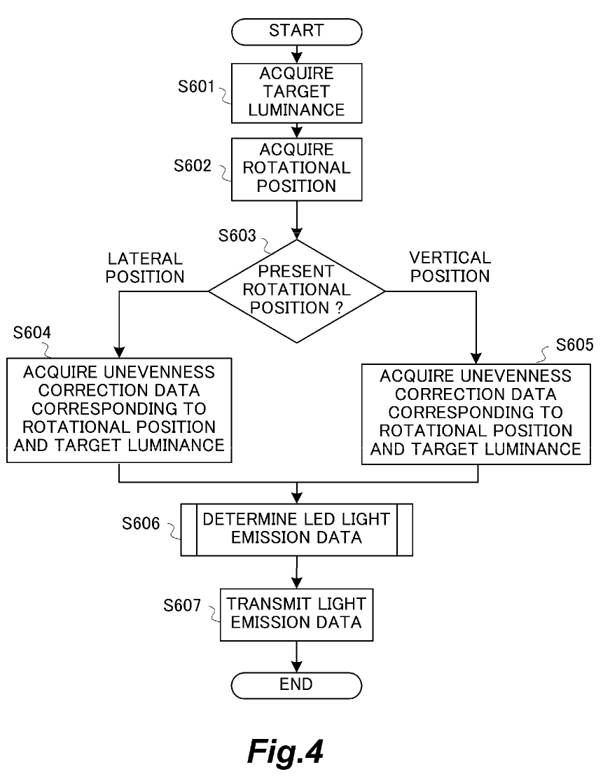

FIG. 4 shows an exemplary operation flow of the backlight control unit 114 when the backlight lighting control is started.

In S601 shown in FIG. 4, if the unevenness correction control unit 118 of the backlight control unit 114 accepts the request to start the lighting control from the system control unit 112, the information about the target luminance of the backlight is acquired from the nonvolatile memory unit 109. The target luminance is the value set by a user. When the user performs the setting, the target luminance is written into the nonvolatile memory unit 109.

In S602, the unevenness correction control unit 118 acquires the screen position information from the screen position detecting unit 113.

In S603, the unevenness correction control unit 118 judges the rotational position of the present screen of the liquid crystal display apparatus 101 on the basis of the acquired screen position information. If it is judged by the unevenness correction control unit 118 that the rotational position of the present screen resides in the “lateral position”, the routine proceeds to S604. If it is judged that the rotational position of the present screen resides in the “vertical position”, the routine proceeds to S605.

In S604 or S605, the unevenness correction data, which corresponds to the target luminance acquired in S601 and the rotational position of the present screen acquired in S602, is acquired from the nonvolatile memory unit 109 by the unevenness correction control unit 118.

For example, if the target luminance is “100 cd/m²”, and the rotational position of the screen resides in the “lateral position”, then the unevenness correction control unit 118 acquires the unevenness correction data shown in FIG. 3A in S604.

If the target luminance is “200 cd/m²”, and the rotational position of the screen resides in the “lateral position”, then the unevenness correction control unit 118 acquires the unevenness correction data shown in FIG. 3B in S604.

If the target luminance is “100 cd/m²”, and the rotational position of the screen resides in the “vertical position”, then the unevenness correction control unit 118 acquires the unevenness correction data shown in FIG. 3C in S605.

If the target luminance is “200 cd/m²”, and the rotational position of the screen resides in the “vertical position”, then the unevenness correction control unit 118 acquires the unevenness correction data shown in FIG. 3D in S605.

In S606, the unevenness correction control unit 118 determines the PWM control values as the LED light emission data for the respective 6 rows and 6 columns of LED blocks, i.e., thirty-six LED blocks in total, with reference to the unevenness correction data acquired from the nonvolatile memory unit 109. If the reference is made to the unevenness correction data shown in FIG. 3A, then the unevenness correction control unit 118 makes reference to the value in the first row and first column in relation to the PWM control value of the LED block “1-1”, and the value is determined to “1999”. Further, the unevenness correction control unit 118 makes reference to the value in the first row and second column in relation to the PWM control value of the LED block “1-2”, and the value is determined to “1996”. In the followings, the unevenness correction control unit 118 determines the thirty-six PWM control values in total corresponding to the LED blocks in the respective rows and the respective columns. The unevenness correction control unit 118 stores the determined thirty-six PWM control values in total as the “present PWM control values” in the memory unit 110.

In S607, the unevenness correction control unit 118 transmits the determined thirty-six PWM control values in total to the light emission data transmitting unit 119. The light emission data transmitting unit 119 transmits the PWM control values corresponding to the respective LED blocks to the LED drivers 401 of the respective LED blocks included in the backlight 115.

In accordance with the operation as described above, the backlight 115 starts the lighting.

Next, an explanation will be made about the process of the backlight control unit 114 executed in a constant cycle after the start of the lighting of the backlight 115. The backlight control unit 114 performs, in the constant cycle, the judging process to judge the presence or absence of the change of the rotational position of the screen and the correcting process to correct the PWM control value transmitted to the backlight 115, after the start of the lighting of the backlight 115. The system control unit 112 requests the start of the execution of the processes as described above to the backlight control unit 114 every time when a certain period of time is counted by the timer unit 111.

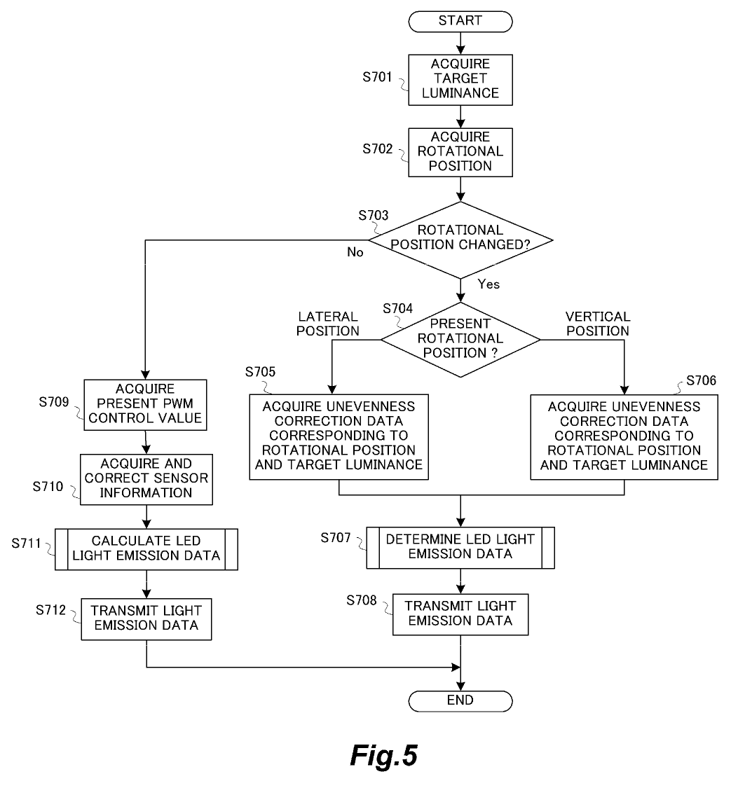

FIG. 5 shows an exemplary operation flow of the backlight control unit 114 executed in the constant cycle after the start of the lighting of the backlight.

In S701 shown in FIG. 5, if the unevenness correction control unit 118 of the backlight control unit 114 accepts the request to start the control from the system control unit 112, the information about the target luminance of the backlight is acquired from the nonvolatile memory unit 109.

In S702, the unevenness correction control unit 118 of the backlight control unit 114 acquires the present screen position information (information about the rotational position of the screen) from the screen position detecting unit 113.

In S703, the unevenness correction control unit 118 judges whether or not the rotational position of the screen of the liquid crystal display apparatus 101 is changed, on the basis of the screen position information acquired one cycle before (when the flow is executed last time) and the present screen position information (when the flow is executed this time) acquired in S702. After the judgment, the unevenness correction control unit 118 stores the present screen position information (obtained this time) in the memory unit 110. If it is judged by the unevenness correction control unit 118 that the rotational position of the screen is not changed, the routine proceeds to S709. If it is judged that the rotational position of the screen is changed, the routine proceeds to S704.

### Operation to be Performed if Rotational Position of Screen is Not Changed

In S709, the unevenness correction control unit 118 acquires the “present PWM control value” from the memory unit 110.

In S710, the sensor control unit 117 acquires the luminance sensor value and the temperature sensor value of each of the LED blocks from the luminance sensor 301 and the temperature sensor 302 arranged in each of the LED blocks of the backlight 115. The sensor control unit 117 converts the acquired luminance sensor value into the PWM control value. The sensor control unit 117 converts the luminance sensor value into the PWM control value by making reference to a table or a relational expression which indicates the correlation between the luminance sensor value and the PWM control value as previously stored in the nonvolatile memory unit 109. Further, the sensor control unit 117 corrects the PWM control value after the conversion, on the basis of the temperature sensor value. The sensor control unit 117 performs the correction of the PWM control value by making reference to a relational expression for the correction calculation and/or a correlation between the temperature sensor value and a correction coefficient as previously stored in the nonvolatile memory unit 109. The sensor control unit 117 stores the corrected PWM control value as “corrected PWM control value” in the memory unit 110.

In S711, the unevenness correction control unit 118 calculates the difference between the “present PWM control value” and the “corrected PWM control value”. The PWM control value, which is to be transmitted to the LED driver 401 included in the backlight 115, is determined in accordance with the following expression on the basis of the difference.

PWM control value=Present PWM control value+(Present PWM control value−Corrected PWM control value)/2

The unevenness correction control unit 118 stores the PWM control value determined by the foregoing expression as the “present PWM control value” in the memory unit 110.

In S712, the PWM control value, which is determined in S711, is transmitted to the light emission data transmitting unit 119 by the unevenness correction control unit 118. The PWM control value, which corresponds to each of the LED blocks, is transmitted by the light emission data transmitting unit 119 to the LED driver 401 of each of the LED blocks included in the backlight 115.

The backlight 115 is lighted or turned ON while the luminance is gradually converged to the target luminance, by repeating the operation as described above.

### Operation to be Performed if Rotational Position of Screen is Changed

In S704, the unevenness correction control unit 118 judges the rotational position of the screen of the liquid crystal display apparatus 101 on the basis of the screen position information acquired in S702. If the rotational position of the screen resides in the “lateral position”, the unevenness correction control unit 118 allows the routine to proceed to S705. If the rotational position of the screen resides in the “vertical position”, the unevenness correction control unit 118 allows the routine to proceed to S706.

In S705 or S706, the unevenness correction control unit 118 acquires, from the nonvolatile memory unit 109, the unevenness correction data corresponding to the target luminance acquired in S701 and the rotational position of the present screen acquired in S702.

For example, if the target luminance is “100 cd/m²”, and the rotational position of the screen resides in the “lateral position”, then the unevenness correction control unit 118 acquires the unevenness correction data shown in FIG. 3A in S705.

If the target luminance is “200 cd/m²”, and the rotational position of the screen resides in the “lateral position”, then the unevenness correction control unit 118 acquires the unevenness correction data shown in FIG. 3B in S705.

If the target luminance is “100 cd/m²”, and the rotational position of the screen resides in the “vertical position”, then the unevenness correction control unit 118 acquires the unevenness correction data shown in FIG. 3C in S706.

If the target luminance is “200 cd/m²”, and the rotational position of the screen resides in the “vertical position”, then the unevenness correction control unit 118 acquires the unevenness correction data shown in FIG. 3D in S706.

The operations in S707 and S708 are the same as or equivalent to the operations in S606 and S607 shown in FIG. 4. Therefore, any explanation thereof is omitted.

According to the operations from S702 to S708, if the rotational position of the screen is changed from the “lateral position” to the “vertical position”, or if the rotational position of the screen is changed from the “vertical position” to the “lateral position”, then the unevenness correction data for determining the PWM control value of LED is changed depending on the rotational position of the screen after the change. The unevenness correction data is the PWM control value which is determined so that the uneven luminance is minimized in the screen in the state in which the screen is disposed at the corresponding rotational position. The correction accuracy of the PWM control value is improved by changing the unevenness correction data depending on the change of the rotational position. Therefore, it is possible to appropriately suppress the uneven luminance in the screen irrelevant to the change of the rotational position of the screen of the liquid crystal display apparatus 101.

### Second Embodiment

A second embodiment of the present invention will be explained below with reference to the drawings.

Main parts or components of a liquid crystal display apparatus according to the second embodiment are the same as or equivalent to those of the liquid crystal display apparatus according to the first embodiment. The difference from the first embodiment is that a tilt angle of a screen can be further changed in addition to the rotational position of the screen in the liquid crystal display apparatus 101 according to the second embodiment. In other words, a support mechanism of the liquid crystal display apparatus 101 is constructed so that the liquid crystal display apparatus 101 is supported rotatably about the axis which is perpendicular to the screen, and the support mechanism is constructed so that the liquid crystal display apparatus 101 is supported rotatably within a predetermined angle range about the axis which is parallel to the screen and which is perpendicular to the vertical direction.

The feature, in which a screen position detecting unit 113 of the second embodiment 2 uses a gyro sensor in order to detect the tilt angle of the screen in addition to the rotational position of the screen, is also the difference from the first embodiment. The screen position detecting unit 113 outputs, as the screen position information, the information about the rotational position and the tilt angle of the present screen of the liquid crystal display apparatus 101.

### Operation of Backlight Control Unit 114

The lighting control of the backlight 115 performed by the backlight control unit 114 will be explained principally about the difference from the first embodiment.

When the tilt angle of the screen is changed, the internal temperature distribution of the liquid crystal display apparatus 101 is changed, for example, due to the change of the heat transfer at the inside of the liquid crystal display apparatus 101. Therefore, the way of appearance of the uneven luminance is also dispersed depending on the change of the tilt angle of the screen.

The liquid crystal display apparatus 101 stores, in the nonvolatile memory unit 109, a table of the PWM control value determined for each of the LED blocks so that the uneven luminance in the screen is minimized, as the unevenness correction data in relation to each of the rotational positions of the screen, each of the tilt angles of the screen, and each of the target luminances at a specified environmental temperature.

The liquid crystal display apparatus 101 of this embodiment stores the unevenness correction data corresponding to one hundred and twenty screens in total for every rotational position of the screen (lateral position, vertical position), every tilt angle of the screen (−5° to 20°, each interval of 5°), and every target luminance of the backlight (from 20 to 200 cd/m², each interval of 20 cd/m²). The PWM control value for each of the LED blocks, which is determined so that the uneven luminance of the liquid crystal display apparatus 101 is minimized at each of the rotational positions, each of the tilt angles, and each of the luminances, is set for each piece of the unevenness correction data. The luminance interval and the tilt angle interval for preparing the unevenness correction data are not limited to those of the example described above.

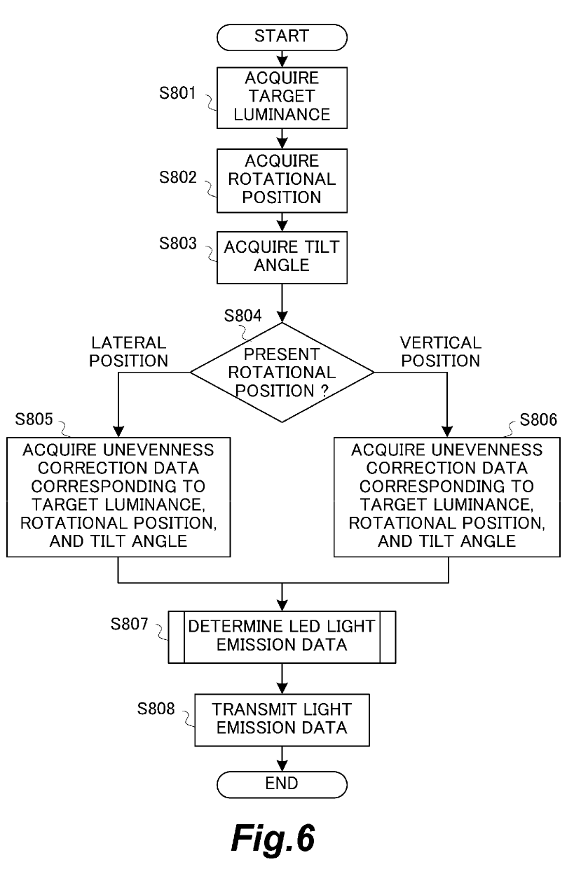

FIG. 6 shows an exemplary operation flow of the backlight control unit 114 when the backlight lighting control is started.

As for S801 and S802, any explanation is omitted, because the operations are the same as or equivalent to those of S601 and S602 shown in FIG. 4 explained in the first embodiment.

In S803, the unevenness correction control unit 118 acquires the tilt angle of the present screen from the screen position detecting unit 113. In accordance with S802 and S803, the unevenness correction control unit 118 acquires the rotational position of the screen and the tilt angle of the screen as the screen position information.

In S804, the unevenness correction control unit 118 judges the rotational position of the present screen of the liquid crystal display apparatus 101 on the basis of the acquired screen position information. If it is judged by the unevenness correction control unit 118 that the rotational position of the screen resides in the “lateral position”, the routine proceeds to S805. If it is judged that the rotational position of the screen resides in the “vertical position”, the routine proceeds to S806.

In S805 or S806, the unevenness correction data, which corresponds to the target luminance acquired in S801, the rotational position of the screen acquired in S802, and the tilt angle of the screen acquired in S803, is acquired from the nonvolatile memory unit 109 by the unevenness correction control unit 118.

As for S807 and S808, any explanation is omitted, because the operations are the same as or equivalent to those of S606 and S607 shown in FIG. 4 explained in the first embodiment.

In accordance with the operation as described above, the backlight 115 starts the lighting.

Next, an explanation will be made about the process by the backlight control unit 114 executed in a constant cycle after the start of the lighting of the backlight 115. The backlight control unit 114 performs, in the constant cycle, the judging process to judge the presence or absence of the change of the rotational position or the tilt angle of the screen and the correcting process to correct the PWM control value transmitted to the backlight 115, after the start of the lighting of the backlight 115. The system control unit 112 requests the start of the execution of the processes as described above to the backlight control unit 114 every time when a certain period of time is counted by the timer unit 111.

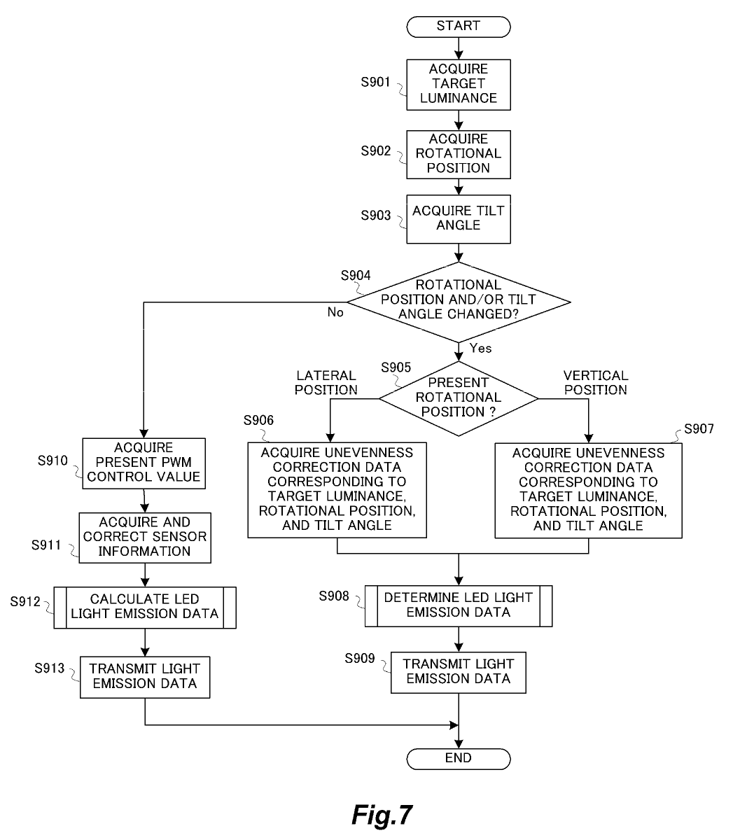

FIG. 7 shows an exemplary operation flow of the backlight control unit 114 executed in the constant cycle after the start of the lighting of the backlight.

As for S901 and S902, any explanation is omitted, because the operations are the same as or equivalent to those of S701 and S702 shown in FIG. 5 explained in the first embodiment.

In S903, the unevenness correction control unit 118 acquires the information about the tilt angle of the present screen from the screen position detecting unit 113.

In S904, the unevenness correction control unit 118 judges whether or not the rotational position of the screen and/or the tilt angle is/are changed, on the basis of the screen position information acquired one cycle before (when the flow is executed last time) and the present screen position information (when the flow is executed this time) acquired in S902 and S903. After the judgment, the unevenness correction control unit 118 stores the present screen position information (obtained this time) in the memory unit 110. If it is judged by the unevenness correction control unit 118 that the rotational position of the screen and/or the tilt angle is/are not changed, the routine proceeds to S910. If it is judged that the rotational position of the screen and/or the tilt angle is/are changed, the routine proceeds to S905.

Operation to be Performed if Rotational Position and/or Tilt Angle of Screen is/are Not Changed

As for S910 and S913, any explanation is omitted, because the operations are the same as or equivalent to those of S709 and S712 shown in FIG. 5 explained in the first embodiment.

Operation to be Performed if Rotational Position and/or Tilt Angle of Screen is/are Changed

In S905, the unevenness correction control unit 118 judges the rotational position of the screen of the liquid crystal display apparatus 101 on the basis of the screen position information acquired in S902. If the rotational position of the screen resides in the “lateral position”, the unevenness correction control unit 118 allows the routine to proceed to S906. If the rotational position of the screen resides in the “vertical position”, the unevenness correction control unit 118 allows the routine to proceed to S907.

In S906 or S907, the unevenness correction control unit 118 acquires, from the nonvolatile memory unit 109, the unevenness correction data corresponding to the target luminance acquired in S901, the rotational position of the screen acquired in S902, and the tilt angle of the screen acquired in S903.

As for the operations of S908 and S909, any explanation is omitted, because the operations are the same as or equivalent to those of S606 and S607 shown in FIG. 4.

According to the operations from S902 to S909, if the rotational position of the screen is changed from the “lateral position” to the “vertical position” or from the “vertical position” to the “lateral position”, and/or if the tilt angle of the screen is changed, then the light emission of LED is controlled on the basis of the unevenness correction data suitable for the rotational position and/or the tilt angle after the change. Therefore, it is possible to appropriately suppress the occurrence of the uneven luminance in the screen irrelevant to the change of the rotational position and/or the tilt angle of the screen of the liquid crystal display apparatus.

The present invention is also applicable to a backlight apparatus of a liquid crystal display apparatus which has a swivel mechanism (oscillating or revolving mechanism) as the mechanism for changing the position of the screen and which is capable of changing the swivel angle as the position of the screen. In this case, the tilt angle referred to in the foregoing explanation is replaced with the swivel angle.

### Third Embodiment

In the first and second embodiments, the description has been made about such an example that the unevenness correction data, which is to be used for determining the PWM control value for LED, is changed to the unevenness correction data corresponding to the position of the screen after the change, at the point in time at which the change of the position of the screen (for example, the rotational position and/or the tilt angle) is detected.

When the position of the screen of the liquid crystal display apparatus is changed, the internal temperature distribution is gradually changed in the liquid crystal display apparatus. In other words, any time-dependent delay is provided until a steady state is given with an internal temperature distribution corresponding to the position of the screen after the change, after the position of the screen of the liquid crystal display apparatus is changed. In view of the above, in a liquid crystal display apparatus according to this embodiment, the unevenness correction data is changed after a predetermined period of time elapses after the change of the position of the screen is detected. This predetermined period of time is hereinafter referred to as “delay time”. The elapse of time is judged by counting the elapsed time after the detection of the change of the position of the screen by using the timer unit 111.

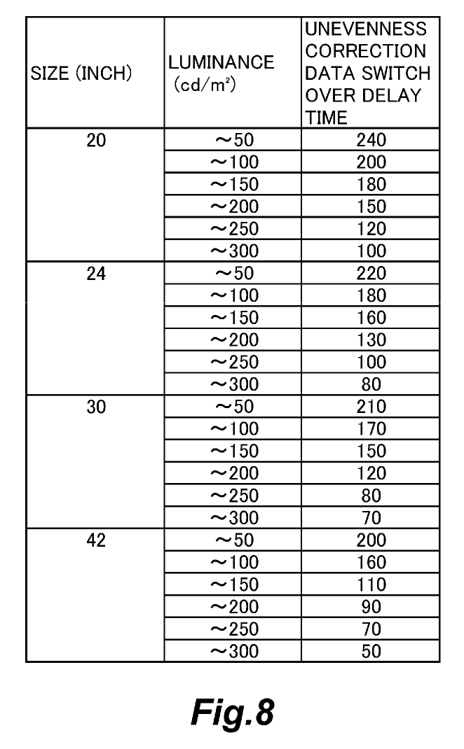

The delay time is previously determined experimentally and empirically on the basis of the time required to converge the transient change of the internal temperature distribution accompanied by the change of the position of the screen of the liquid crystal display apparatus so that the internal temperature distribution arrives at the steady state. The information about the delay time is stored in the nonvolatile memory unit 109. The time, which is required to converge the internal temperature change, differs depending on, for example, the structure (for example, the screen size) of the liquid crystal display apparatus and the target luminance. In the case of the liquid crystal display apparatus 101 of this embodiment, the nonvolatile memory unit 109 previously stores a table (see FIG. 8) which is provided to determine the delay time depending on the display screen size of the liquid crystal display apparatus and the target luminance of the backlight to be provided when the change of the position of the screen is detected.

The unevenness correction control unit 118 acquires the unevenness correction data, for example, in S705 or S706 shown in FIG. 5. After that, the information of the delay time corresponding to the target luminance and the screen size of the liquid crystal display apparatus 101 is acquired from the nonvolatile memory unit 109 by making reference to the table shown in FIG. 8. The unevenness correction control unit 118 judges the elapse of the delay time acquired as described above on the basis of the count of the timer unit 111. If it is judged that the delay time elapses, the process of S707 is executed.

According to this embodiment, if the change of the position of the screen is detected, the LED light emission control is changed to the control which is based on the use of the unevenness correction data corresponding to the position of the screen after the change, after it is judged that the internal temperature distribution of the liquid crystal display apparatus has converged to the steady state in the position of the screen after the change. Therefore, it is possible to suppress the uneven luminance in the screen more reliably.

### Fourth Embodiment

In the third embodiment, the description has been made about such an example that the change of the unevenness correction data is delayed until the predetermined delay time elapses after the detection of the change of the position of the screen (for example, the rotational position and/or the tilt angle) of the liquid crystal display apparatus.

In this embodiment, an explanation will be made about such an example that the change of the unevenness correction data is delayed until the temperature difference between specified points included in the backlight is coincident with a predetermined reference value after the detection of the change of the position of the screen of the liquid crystal display apparatus. That is, in this embodiment, the temperature difference between two LED blocks is detected to judge whether or not the detected value of the temperature difference is coincident with the predetermined reference value. In this embodiment, the unevenness correction data is changed after a number of combinations, which are included in a plurality of predetermined combinations of the two LED blocks and for which it is judged that the detected value of the temperature difference is coincident with the reference value, are provided so that the number is not less than a predetermined number.

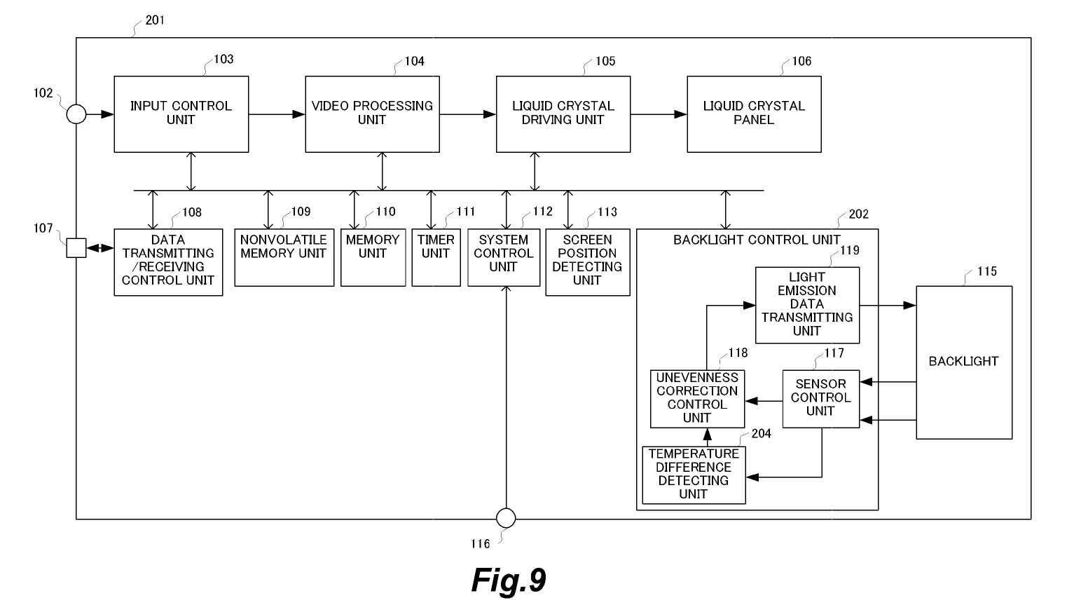

FIG. 9 shows a block diagram illustrating main parts or components of a liquid crystal display apparatus 201 according to this embodiment. In FIG. 9, the functional blocks, which are equivalent to those of the liquid crystal display apparatus 101 of the first embodiment shown in FIG. 1, are designated by the same reference numerals as those shown in FIG. 1. The liquid crystal display apparatus 201 of this embodiment shown in FIG. 9 is different from the liquid crystal display apparatus 101 of the first embodiment shown in FIG. 1 in relation to a backlight control unit 202. The backlight control unit 202 of this embodiment has a temperature difference detecting unit 204.

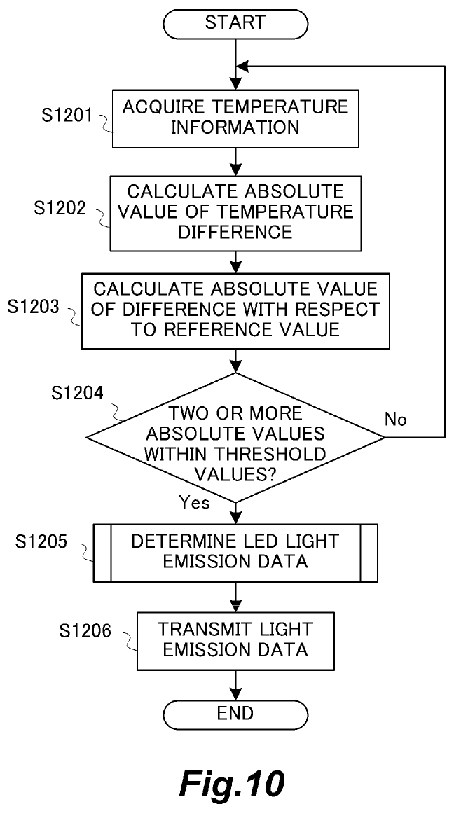

FIG. 10 shows an exemplary operation flow of the backlight control unit 202 after the change of the position of the screen is detected in the liquid crystal display apparatus 201.

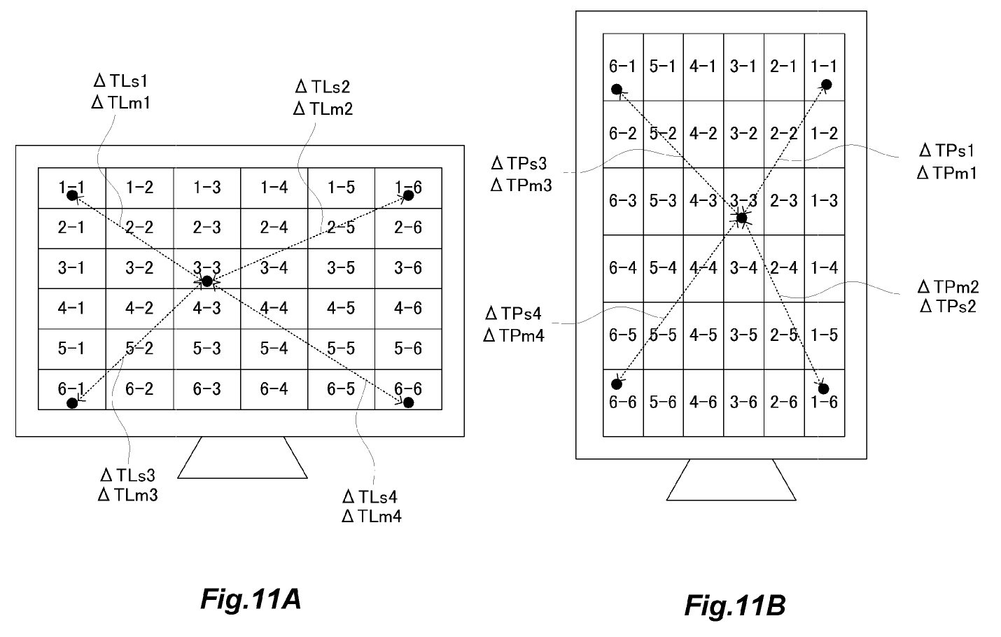

In S1201, the temperature difference detecting unit 204 of the backlight control unit 202 acquires the temperature sensor values of predetermined LED blocks (temperature detection objective blocks) by the aid of the sensor control unit 117. FIG. 11 shows exemplary temperature detection objective blocks by way of example. With reference to FIG. 11, five LED blocks “1-1”, “1-6”, “3-3”, “6-1”, and “6-6”, which are affixed with black circles, are the temperature detection objective blocks. The number and the positions of the temperature detection objective blocks are not limited thereto. FIG. 11A shows a state in which the rotational position of the screen resides in the lateral position, and FIG. 11B shows a state in which the rotational position of the screen resides in the vertical position.

In S1202, the temperature difference detecting unit 204 calculates the absolute value of the difference in the temperature sensor value between the two temperature detection objective blocks (referred to as “inter-block temperature difference”). In this embodiment, the inter-block temperature difference is calculated for the four combinations of the two temperature detection objective blocks (“1-1” and “3-3”, “1-6” and “3-3”, “6-1” and “3-3”, “6-6” and “3-3”).

As for the combination of the temperature detection objective blocks “1-1” and “3-3”, it is assumed that ΔTLm1 represents the inter-block temperature difference obtained when the rotational position of the screen resides in the lateral position and ΔTPm1 represents the inter-block temperature difference obtained when the rotational position of the screen resides in the vertical position.

As for the combination of the temperature detection objective blocks “1-6” and “3-3”, it is assumed that ΔTLm2 represents the inter-block temperature difference obtained when the rotational position of the screen resides in the lateral position and ΔTPm2 represents the inter-block temperature difference obtained when the rotational position of the screen resides in the vertical position.

As for the combination of the temperature detection objective blocks “6-1” and “3-3”, it is assumed that ΔTLm3 represents the inter-block temperature difference obtained when the rotational position of the screen resides in the lateral position and ΔTPm3 represents the inter-block temperature difference obtained when the rotational position of the screen resides in the vertical position.

As for the combination of the temperature detection objective blocks “6-6” and “3-3”, it is assumed that ΔTLm4 represents the inter-block temperature difference obtained when the rotational position of the screen resides in the lateral position and ΔTPm4 represents the inter-block temperature difference obtained when the rotational position of the screen resides in the vertical position.

The combination of the temperature detection objective blocks for calculating the inter-block temperature difference is not limited thereto.

In S1203, the temperature difference detecting unit 204 calculates the absolute value of the difference from the predetermined reference value for the four inter-block temperature differences (ΔTLmN or ΔTPmN, N=value of 1 to 4) calculated in S1202 respectively. The reference value is determined for each of the combinations of the temperature detection objective blocks in order to calculate the inter-block temperature difference. In this procedure, it is assumed that the reference value corresponding to the inter-block temperature difference ΔTLmN (N=1 to 4) is designated as ΔTLsN (N=1 to 4), and the reference value corresponding to the inter-block temperature difference ΔTPmN (N=1 to 4) is designated as ΔTPsN (N=1 to 4).

Each of the reference values is previously determined on the basis of the value of each of the inter-block temperature differences obtained when the internal temperature distribution is in the steady state in the liquid crystal display apparatus 201. The temperature difference detecting unit 204 judges whether or not each of the inter-block temperature differences is coincident with each of the reference values. In this case, if the absolute value of the difference between the inter-block temperature difference and the reference value is not more than a certain threshold value, it is judged that the inter-block temperature difference is coincident with the reference value. The method for judging whether or not the inter-block temperature difference is coincident with the reference value is not limited to the example described above.

In S1204, the temperature difference detecting unit 204 judges whether or not a number of inter-block temperature differences, which are judged to be coincident with the reference values, are provided and whether or not the number is not less than a predetermined number. The predetermined number is previously determined so that it is possible to judge that the internal temperature distribution of the liquid crystal display apparatus 201 is in the steady state. In this case, the predetermined number is 2. However, there is no limitation thereto. If it is judged that two or more inter-block temperature differences are coincident with the reference values, the temperature difference detecting unit 204 allows the routine to proceed to S1205.

In S1205, the unevenness correction control unit 118 determines the PWM control value of LED for each of the LED blocks by using the unevenness correction data corresponding to the position of the screen after the change.

On the other hand, if a number of inter-block temperature differences, which are judged to be coincident with the reference values, are provided, and the number is less than the predetermined number (2 in this case) in S1204, then the temperature difference detecting unit 204 allows the routine to return to S1201.

According to this embodiment, the change to the unevenness correction data is delayed until it is judged that the internal temperature distribution in the liquid crystal display apparatus is in the steady state after the detection of the change of the position of the screen of the liquid crystal display apparatus. It is judged whether or not the internal temperature distribution of the liquid crystal display apparatus is in the steady state on the basis of the comparison between the reference value and the measured value of the temperature difference between the LED blocks. Therefore, it is possible to suppress the uneven luminance in the screen more appropriately.

In this embodiment, the temperature sensor 302 may be provided for only the LED block which serves as the temperature detection objective block.

### Modified Embodiment

The first to fourth embodiments have been explained above in relation to such an example that the unevenness correction data, which is determined to minimize the uneven luminance for each of the positions of the screen, is changed depending on the change of the position of the screen.

The present invention is also applicable to a backlight apparatus which uses LEDs of a plurality of colors such as three primary colors RGB for the light source. In this case, the light emission characteristic of LED also includes the color dependency in addition to the individual difference and the temperature dependency described above. For example, the degree of decrease in the luminance, which is caused by the increase in the temperature, is large in red LED as compared with LEDs of the other colors. Therefore, any uneven color arises depending on the internal temperature distribution of the liquid crystal display apparatus. The way of appearance of the uneven color is dispersed in some cases depending on the position of the screen in the same manner as the uneven luminance.

In view of the above, when the present invention is applied to a backlight apparatus which uses three primary color LEDs or multi-primary color LEDs as the light source, then the unevenness correction data is stored for each of the colors of LEDs, each of the positions of the screen, and each of the target luminances of the respective colors, and the light emission of LEDs of the respective colors is controlled by using the concerning unevenness correction data as in the respective embodiments described above. Accordingly, it is possible to suppress the uneven luminance and the uneven color in the screen irrelevant to the position of the screen in the liquid crystal display apparatus which uses multi-primary color LEDs such as RGB for the light source of the backlight.

The present invention is also applicable to an image display apparatus which performs the local dimming. The local dimming is such a technique that the display contrast is improved by setting the target luminance for each of LED blocks in conformity with an image in a display area corresponding to each of LED blocks. In the respective embodiments described above, the unevenness correction data is the data provided in the screen unit (set of the PWM control values for all of the LED blocks) in relation to each of the positions of the screen and each of the target luminances, because the target luminance is identical for all of the LED blocks. In the case of the image display apparatus for performing the local dimming, the target luminance differs for each of the LED blocks.

Therefore, it is appropriate that the unevenness correction data is the data provided in the LED block unit in relation to each of the positions of the screen and each of the target luminances. That is, the unevenness correction data of the concerning LED block, which corresponds to the concerning target luminance and the position of screen, is read from the nonvolatile memory depending on the position of the screen and the target luminance for each of the LED blocks determined by the local dimming, and the light emission of LED of the concerning LED block is controlled.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-156847, filed on Jul. 15, 2011, which is hereby incorporated by reference herein in its entirety.

What is claimed is:

1. A backlight apparatus of an image display apparatus capable of changing an position of a screen, the backlight apparatus comprising:
a plurality of light sources which are provided for a plurality of light source blocks and for which light emission can be controlled independently in relation to each of the light source blocks;
a storage unit which stores unevenness correction data as data to be used in order to determine a driving signal for the light source of each of the light source blocks, the unevenness correction data being determined so that a luminance of each of the light source blocks is included within a predetermined allowable range with respect to a target luminance in relation to each of a plurality of predetermined positions of the screen;
an acquiring unit which acquires the position of the screen; and
a control unit which determines the driving signal for the light source of each of the light source blocks by using the unevenness correction data corresponding to the position of the screen.

2. The backlight apparatus according to claim 1, wherein:
the unevenness correction data is data which is determined for each of the plurality of predetermined positions of the screen and each of the target luminances of the backlight apparatus;
the acquiring unit further acquires the target luminance of the backlight apparatus; and
the control unit determines the driving signal for the light source of each of the light source blocks by using the unevenness correction data corresponding to the position of the screen and the target luminance of the backlight apparatus.

3. The backlight apparatus according to claim 2, further comprising:
a setting unit which sets the target luminance for each of the light source blocks in conformity with an image disposed in a display area corresponding to each of the light source blocks, wherein:
the control unit determines the driving signal for the light source of each of the light source blocks by using the unevenness correction data corresponding to the position of the screen and the target luminance of the light source block in relation to each of the light source blocks.

4. The backlight apparatus according to claim 1, further comprising:
a detecting unit which detects any change of the position of the screen, wherein:
the unevenness correction data, which is used to determine the driving signal for the light source of each of the light source blocks, is changed by the control unit to the unevenness correction data corresponding to the position of the screen to be provided after being changed, if any change of the position of the screen is detected.

5. The backlight apparatus according to claim 4, wherein the unevenness correction data, which is used to determine the driving signal for the light source of each of the light source blocks, is changed by the control unit to the unevenness correction data corresponding to the position of the screen to be provided after being changed, after a predetermined period of time elapses after any change of the position of the screen is detected.

6. The backlight apparatus according to claim 5, wherein the control unit determines the predetermined period of time depending on a screen size of the image display apparatus and the target luminance of the backlight apparatus.

7. The backlight apparatus according to claim 4, further comprising:
a temperature difference detecting unit which detects a temperature difference between the two light source blocks; and
a judging unit which judges whether or not a detected value of the temperature difference between the two light source blocks is coincident with a predetermined reference value, wherein:
the unevenness correction data, which is used to determine the driving signal for the light source of each of the light source blocks, is changed by the control unit to the unevenness correction data corresponding to the position of the screen to be provided after being changed, after a number of combinations, each of which is included in a plurality of predetermined combinations of the two light source blocks and each of which is judged by the judging unit to have the detected value of the temperature difference coincident with the reference value, are provided so that the number is not less than a predetermined number, after any change of the position of the screen is detected.

8. The backlight apparatus according to claim 1, wherein the image display apparatus is capable of changing at least any one of a rotational position about an axis which is perpendicular to the screen and a tilt angle about an axis which is parallel to the screen and which is perpendicular to a vertical direction, as the position of the screen.

9. The backlight apparatus according to claim 1, wherein:
each of the light source blocks has the light sources of a plurality of colors; and
the unevenness correction data is data which is determined for each of the colors of the light sources, each of the plurality of predetermined positions of the screen, and each of the target luminances of the respective colors of the backlight apparatus.

10. An image display apparatus comprising:
the backlight apparatus as defined in claim 1; and
a liquid crystal panel which is illuminated by the backlight apparatus.

11. A method for controlling a backlight apparatus of an image display apparatus capable of changing an position of a screen, the backlight apparatus comprising a plurality of light sources which are provided for a plurality of light source blocks and for which light emission can be controlled independently in relation to each of the light source blocks, the method comprising:
a reading step of reading unevenness correction data as data to be used in order to determine a driving signal for the light source of each of the light source blocks, the unevenness correction data being determined so that a luminance of each of the light source blocks is included within a predetermined allowable range with respect to a target luminance in relation to each of a plurality of predetermined positions of the screen;
an acquiring step of acquiring the position of the screen; and
a control step of determining the driving signal for the light source of each of the light source blocks by using the unevenness correction data corresponding to the position of the screen.

12. The method for controlling the backlight apparatus according to claim 11, wherein:
the unevenness correction data is data which is determined for each of the plurality of predetermined positions of the screen and each of the target luminances of the backlight apparatus;
the target luminance of the backlight apparatus is further acquired in the acquiring step; and
the driving signal for the light source of each of the light source blocks is determined in the control step by using the unevenness correction data corresponding to the position of the screen and the target luminance of the backlight apparatus.

13. The method for controlling the backlight apparatus according to claim 12, further comprising:
a setting step of setting the target luminance for each of the light source blocks in conformity with an image disposed in a display area corresponding to each of the light source blocks, wherein:
the driving signal for the light source of each of the light source blocks is determined in the control step by using the unevenness correction data corresponding to the position of the screen and the target luminance of the light source block in relation to each of the light source blocks.

14. The method for controlling the backlight apparatus according to claim 11, further comprising:
a detecting step of detecting any change of the position of the screen, wherein:
the unevenness correction data, which is used to determine the driving signal for the light source of each of the light source blocks, is changed in the control step to the unevenness correction data corresponding to the position of the screen to be provided after being changed, if any change of the position of the screen is detected.

15. The method for controlling the backlight apparatus according to claim 14, wherein the unevenness correction data, which is used to determine the driving signal for the light source of each of the light source blocks, is changed in the control step to the unevenness correction data corresponding to the position of the screen to be provided after being changed, after a predetermined period of time elapses after any change of the position of the screen is detected.

16. The method for controlling the backlight apparatus according to claim 15, wherein the predetermined period of time is determined in the control step depending on a screen size of the image display apparatus and the target luminance of the backlight apparatus.

17. The method for controlling the backlight apparatus according to claim 14, further comprising:
a temperature difference detecting step of detecting a temperature difference between the two light source blocks; and
a judging step of judging whether or not a detected value of the temperature difference between the two light source blocks is coincident with a predetermined reference value, wherein:
the unevenness correction data, which is used to determine the driving signal for the light source of each of the light source blocks, is changed in the control step to the unevenness correction data corresponding to the position of the screen to be provided after being changed, after a number of combinations, each of which is included in a plurality of predetermined combinations of the two light source blocks and each of which is judged in the judging step to have the detected value of the temperature difference coincident with the reference value, are provided so that the number is not less than a predetermined number, after any change of the position of the screen is detected.
